(19) United States
(12) Patent Application Publication
(10) Pub. No.: US 2026/0309428 A1
(43) Pub. Date: Oct. 8, 2026

(54) HEAT EXCHANGER

(71) Applicant: Hanon Systems, Daejeon (KR)

(72) Inventor: Young-Ha JEON, Daejeon (KR)

(73) Assignee: Hanon Systems, Daejeon (KR)

(21) Appl. No.: 19/123,217

(22) PCT Filed: Feb. 22, 2024
(86) PCT No.: PCT/KR2024/002320

§ 371 Date: Apr. 22, 2025

(30) Foreign Application Priority Data
Feb. 22, 2023 (KR) 10-2023-0023763

(51) Int. Cl. F28D 1/053; F28F 1/32; F28F 9/02

(52) U.S. Cl. CPC F28D 1/05383; F28F 1/32; F28F 9/02; F28F 2215/00

(57) ABSTRACT

The present invention relates to a heat exchanger, particularly, a two-row heat exchanger. Accordingly, the present invention has been made in an effort to solve the above-mentioned problem in the related art, and an object of the present invention is to provide a heat exchanger, i.e., a two-row heat exchanger in which coolants in different cooling cycles flow in respective rows, and a tube width in a first row is larger than a tube width in a second row in order to solve a problem in which heat exchange performance deteriorates in case that temperatures of the coolants flowing in the first and second rows are greatly different in accordance with modes for cooling and heating an interior.

### TECHNICAL FIELD

The present invention relates to a heat exchanger, and more particularly, to a shape design for improving heat exchange performance in a two-row heat exchanger.

### BACKGROUND ART

In general, not only components such as an engine for operating a vehicle are provided in an engine room of the vehicle, but also various heat exchangers such as a radiator, an intercooler, an evaporator, and a condenser for cooling the components such as the engine in the vehicle or adjusting an air temperature in an interior of the vehicle are provided in the engine room of the vehicle. In general, heat exchange media flow in the heat exchangers. The heat exchange medium in the heat exchanger exchanges heat with outside air present outside the heat exchanger, such that the cooling operation or the heat dissipation is performed. The heat exchanger is generally shaped to include a plurality of tubes disposed in parallel with one another so that the refrigerant flows therethrough, and a pair of header tanks provided at two opposite ends of each of tube rows including the tubes.

A flow of the refrigerant in the heat exchanger variously varies depending on the purpose of the heat exchanger or the position at which the heat exchanger is provided. The tubes are usually formed in a single row or disposed in a plurality of rows, i.e., two or more rows in a forward/rearward direction. In an integrated heat exchanger having tubes disposed in a plurality of rows, heat exchange media having different operating temperature ranges flow in regions separated from one another. The heat exchanger has an advantage of improving spatial utilization of an engine room because a volume of a cooling module is basically decreased. In addition, in case that an inlet and an outlet are separately formed in first and second rows, the heat exchange media independently flow in the rows. Therefore, the heat exchange media, which flow to the respective regions, may be variously changed to a refrigerant, a coolant, a high-temperature coolant, a low-temperature coolant, and the like in accordance with the user's necessity. Several patent documents, such as Japanese Patent No. 7,073,863 (“Thermal Management System for Vehicle”, May 16, 2022) disclose these types of heat exchangers.

FIG. 1 is a view illustrating one embodiment of a two-row heat exchanger. As illustrated, a heat exchanger 100 includes a pair of header tanks 110 having therein fluid flow spaces and provided in two rows, and a plurality of tubes 120 arranged in two rows and each having two opposite ends fixed to the pair of header tanks 110, which are disposed to be spaced apart from each other, to define flow paths for heat exchange media. Fins interposed between the tubes 120 may be further provided to improve heat dissipation performance, and the fins are excluded from the drawing in order to briefly describe the drawing. In addition, as described above, in the two-row heat exchanger of the embodiment illustrated in FIG. 1, an inlet and an outlet are separately formed in the first and second rows, such that the heat exchange media flow independently in the respective rows.

FIG. 2 is a view illustrating a temperature distribution for each mode of the two-row heat exchanger in the related art. Based on a flow direction of air passing through the tube 120, a tube row disposed at a side at which air is introduced is referred to as a first tube row 121, and a tube row disposed at a side at which air is discharged is referred to as a second tube row 122. As described above, the heat exchange media may separately flow in the first and second rows. For example, in case that the heat exchanger 100 is an integrated heater/cooler for a secondary loop system, the coolants, which circulate through different cooling cycles, may respectively flow in the first tube row 121 and the second tube row 122. In this case, in an overall cooling mode, the cold coolant flows in both the first and second tube rows 121 and 122, such that a low temperature is implemented. In an overall heating mode, the hot coolant flows in both the first and second tube rows 121 and 122, such that a high temperature is implemented. Meanwhile, in a dehumidification and temperature adjustment mode, the cold coolant flows in the first tube row 121, and the hot coolant flows in the second tube row 122, such that the air, from which moisture, which is condensed when the air is cooled while passing through the first tube row 121, is removed, is heated to an appropriate temperature while passing through the second tube row 122 and supplied into a vehicle interior.

An air conditioning system for adjusting an air temperature in the vehicle interior will be described more specifically. The air conditioning system is basically configured such that a compressor, a condenser, an expansion valve, and an evaporator are connected to constitute one loop, and a refrigerant circulates. In this case, the air cooled by the evaporator is blown into the vehicle interior, such that the vehicle interior is cooled. Because this system directly performs the cooling operation, this system is called a direct cooling system or a primary loop.

Meanwhile, the refrigerant, which flows through the primary loop, has a significant amount of thermal energy. Therefore, the refrigerant is used to exchange heat with a separate heat exchange medium (e.g., coolant), such that the primary loop is linked with another cooling system. The system linked with the primary loop is called a secondary loop. FIG. 6 is a view illustrating an embodiment of an air conditioning system having primary and secondary loops, a refrigerant circulates through a left primary loop including a compressor, a condenser, an expansion valve, and a chiller, and a coolant circulates through a right secondary loop including a pump, a chiller, and a cooler. In the embodiment in FIG. 6, the coolant is cooled as the refrigerant exchanges heat with the coolant in the chiller, and the low-temperature coolant cools ambient air while passing through the cooler, such that the interior is cooled. This system is clearly disclosed in Korean Patent Laid-Open No. 2019-0124931 (“Heat Exchange System for Vehicle”, Nov. 6, 2019).

The embodiment in FIG. 6 is just a very simple example, and the secondary loop is used to perform only the cooling operation. However, the actual system using the primary and secondary loops may have a more complicated configuration and implement various air conditioning modes such as cooling, heating, and dehumidifying modes by using a flow of the refrigerant or coolant. The two-row heat exchanger described with reference to FIGS. 1 and 2 and configured such that the heat exchange media having different temperature ranges flow in the respective rows is suitable to be applied to this system.

The heat exchanger configured as described above is used after being changed in structure only to the extent that the inlet and the outlet are separately formed in the first and second rows, and the heat exchanger uses the basic two-row heat exchanger configuration in an intact manner. However, it has been found that the performance of the two-row heat exchanger in the related art is insufficient because of a difference in thermal load between the first and second rows. Therefore, it has been consistently pointed out that design improvement for optimizing the two-row heat exchanger for particular applications is required.

### DOCUMENTS OF RELATED ART

### Patent Documents

(Patent Document 1) Japanese Patent No. 7,073,863 (“Thermal Management System for Vehicle”, May 16, 2022)
(Patent Document 2) Korean Patent Laid-Open No. 2019-0124931 (“Heat Exchange System for Vehicle”, Nov. 6, 2019)

### DISCLOSURE

### Technical Problem

Accordingly, the present invention has been made in an effort to solve the above-mentioned problem in the related art, and an object of the present invention is to provide a heat exchanger, i.e., a two-row heat exchanger in which coolants in different cooling cycles flow in respective rows, and a tube width in a first row is larger than a tube width in a second row in order to solve a problem in which heat exchange performance deteriorates in case that temperatures of the coolants flowing in the first and second rows are greatly different in accordance with modes for cooling and heating an interior.

### Technical Solution

In order to achieve the above-mentioned object, the present invention provides a heat exchanger 100 including: a pair of header tanks 110 provided in two rows and each having therein a fluid flow space in which a heat exchange medium flows; and a plurality of tubes 120 arranged in two rows and each having two opposite ends fixed to the pair of header tanks 110, which are disposed to be spaced apart from each other, to form a flow path for the heat exchange medium, in which when a tube row disposed at a side at which air is introduced is referred to as a first tube row 121 and a tube row disposed at a side at which air is discharged is referred to as a second tube row 122 based on a flow direction of the air passing through the tube 120, a tube width t1 of the tube 120 in the first tube row 121 is larger than a tube width t2 of the tube 120 in the second tube row 122.

In this case, in the heat exchanger 100, the tube width t1 of the first tube row 121 may be formed to have a size in a range of 120 to 200% of the tube width t2 of the second tube row 122.

In addition, the heat exchanger 100 may include: a plurality of fins 130 interposed between the tubes 120 and extending to be in contact with both the first tube row 121 and the second tube row 122, in which a plurality of louvers arranged in the flow direction of the air are formed on the fin 130.

When a louver row having the plurality of louvers disposed at a side at which air is introduced is referred to as a first louver row 131 and a louver row disposed at a side at which air is discharged is referred to as a second louver row 132 in the fin 130, angles at which the first louver row 131 and the second louver row 132 are inclined may be formed in opposite shapes symmetric to each other.

In addition, in the fin 130, a bank 133, which is a region in which the first louver row 131 and the second louver row 132 are spaced apart from each other, may be formed at a center of the fin 130.

In addition, the fin 130 may be formed such that the bank 133 is disposed in a region in which the fin 130 is in contact with the first tube row 121.

In addition, the fin 130 may be formed such that at least one louver is disposed between the first tube row 121 and the second tube row 122.

In addition, a width (w) of the louver 135 may be formed to have a size in a range of 80 to 90% of a width (W) of the fin 130.

In addition, in the heat exchanger 100, the first tube row 121 and the second tube row 122 are completely isolated from each other so that heat exchange media having different temperatures flow.

In addition, in the heat exchanger 100, coolants circulating through different cooling cycles may respectively flow in the first tube row 121 and the second tube row 122.

In addition, in the heat exchanger 100, in a dehumidification and temperature adjustment mode or a heating mode, a temperature of the heat exchange medium flowing in the first tube row 121 may be lower than a temperature of the heat exchange medium flowing in the second tube row 122.

In addition, in the heat exchanger 100, a first inlet port 151 and a first outlet port 152 for allowing one heat exchange medium to flow may be provided in the first tube row 121, and a second inlet port 153 and a second outlet port 154 for allowing the other heat exchange medium to flow may be provided in the second tube row 122 independently of the first inlet port 151 and the first outlet port 152.

### Advantageous Effects

According to the present invention, in the two-row heat exchanger, i.e., in the heat exchanger in which the inlet and the outlet are separately provided in the first and second rows, the width of the first row is larger than the width of the second row based on the flow direction of the air, thereby improving overall heat exchange performance of the heat exchanger. More specifically, in the present invention, in consideration of the configuration in which a higher thermal load occurs in the first row in which heat exchange with air is generally performed first, a design in which the width of the first row is larger than the width of the second row is introduced. However, in this case, a loss may be caused by heat transfer between the first and second rows. In the present invention, the position of the bank of the fin having the louver is spaced apart from the spacing position between the tube rows, which may maximally prevent a loss caused by thermal conduction.

### DESCRIPTION OF DRAWINGS

FIG. 1 is a view illustrating one embodiment of a two-row heat exchanger.

FIG. 2 is a view illustrating a temperature distribution for each mode of the two-row heat exchanger in the related art.

FIG. 3 is a view illustrating a temperature distribution for each mode of a two-row heat exchanger of the present invention.

FIG. 4 is a detailed view illustrating the two-row heat exchanger of the present invention in a tube cross-section direction and a fin cross-section direction.

FIG. 5 is a view illustrating a thermal conduction region of the two-row heat exchanger of the present invention in the tube cross-section direction.

FIG. 6 is a view illustrating an embodiment of an air conditioning system having primary and secondary loops.

### DESCRIPTION OF REFERENCE NUMERALS

100: Heat exchanger
110: Header tank
120: Tube
121: First tube row
122: Second tube row
130: Fin
131: First louver row
132: Second louver row
133: Bank

### MODE FOR INVENTION

Hereinafter, a heat exchanger according to the present invention configured as described above will be described in detail with reference to the accompanying drawings.

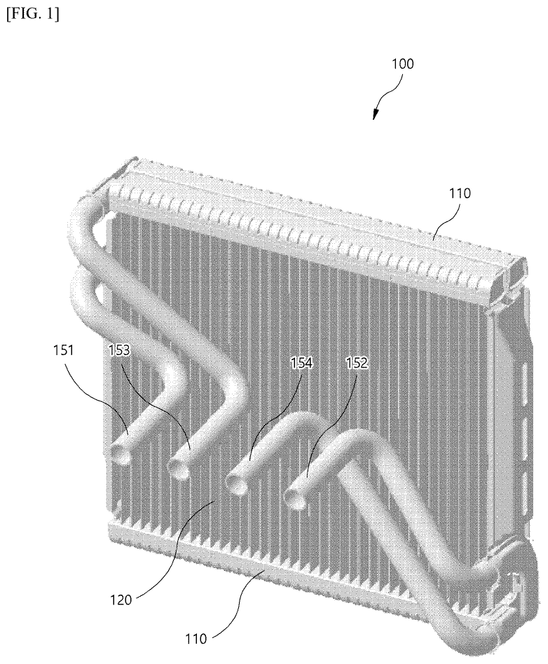

A basic shape of a heat exchanger 100 of the present invention depends on a basic configuration illustrated in FIG. 1. That is, the heat exchanger 100 of the present invention also basically includes a pair of header tanks 110 provided in two rows and having therein fluid flow spaces so that heat exchange media flow therein, and a plurality of tubes 120 arranged in two rows and each having two opposite ends fixed to the pair of header tanks 110, which are disposed to be spaced apart from each other, to define flow paths for heat exchange media. Even in this case, based on a flow direction of air passing through the tube 120, a tube row disposed at a side at which air is introduced is referred to as a first tube row 121, and a tube row disposed at a side at which air is discharged is referred to as a second tube row 122.

In addition, a first inlet port 151 and a first outlet port 152 for allowing one heat exchange medium to flow may be provided in the first tube row 121, and a second inlet port 153 and a second outlet port 154 for allowing the other heat exchange medium to flow may be provided in the second tube row 122 independently of the first inlet port 151 and the first outlet port 152, such that the first tube row 121 and the second tube row 122 may be completely isolated from each other so that the heat exchange media having different temperatures may flow. In this case, in one embodiment, the heat exchanger 100 may be an integrated heater/cooler for a secondary loop system, as described above. In this case, the coolants circulating through different cooling cycles may respectively flow in the first tube row 121 and the second tube row 122. More specifically, as described below in more detail, in a dehumidification and temperature adjustment mode or a heating mode, a temperature of the heat exchange medium flowing in the first tube row 121 may be lower than a temperature of the heat exchange medium flowing in the second tube row 122.

In the related art, a thermal load in the first row is higher than a thermal load in the second row when the heat exchanger operates, which causes a problem of a loss of performance. In the present invention, in consideration of this problem, a tube width t1 of the tube 120 in the first tube row 121 is larger than a tube width t2 of the tube 120 in the second tube row 122.

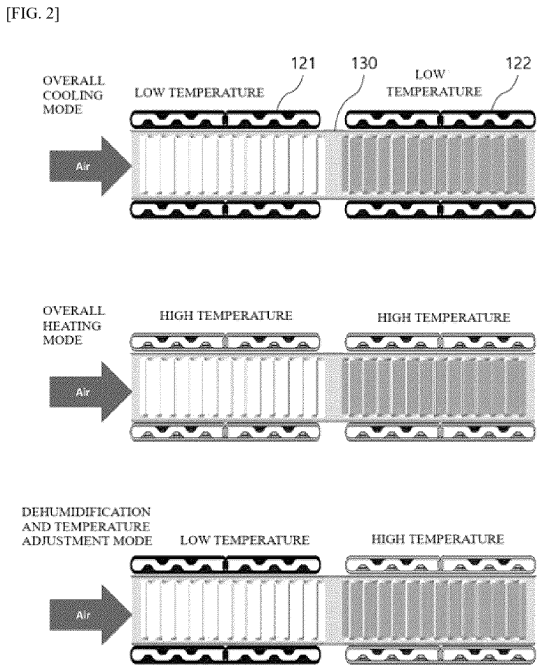

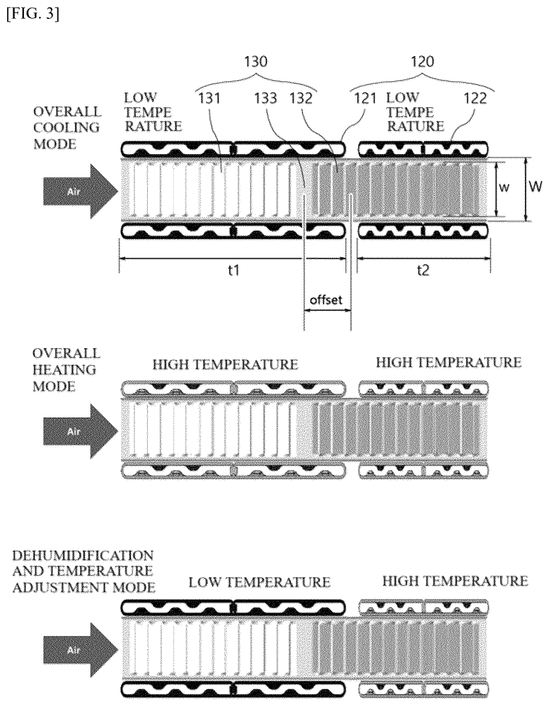

FIG. 3 illustrates a temperature distribution for each mode of the two-row heat exchanger of the present invention in a tube cross-section direction, such that a difference between the tube width t1 of the first tube row 121 and the tube width t2 of the second tube row 122 is explicitly shown. In comparison with the related art in FIG. 2, a heat exchanger in the related art is merely manufactured by attaching two one-row heat exchangers side by side, such that the first and second tube rows have the same tube width. In contrast, in the present invention, it can be clearly ascertained that the tube width t1 of the first tube row 121 is larger than the tube width t2 of the second tube row 122. With this configuration, particularly in the dehumidification and temperature adjustment mode, a thermal load, which is relatively more excessively applied to the first tube row 121 in comparison with the second tube row 122, may be further mitigated. Therefore, as a result, the overall heat exchange performance may be improved.

The description will be more specific as follows. In an overall cooling mode or an overall heating mode in which the cold or hot coolant flows in both the first and second tube rows 121 and 122, there is no need to consider a difference in thermal load or the like. However, in the dehumidification and temperature adjustment mode, the cold coolant flows in the first tube row 121, and the hot coolant flows in the second tube row 122. First, air is cooled while passing through the first tube row 121. In this case, the air is dehumidified as moisture is condensed and removed. Next, the air is heated to an appropriate temperature while passing through the second tube row 122 and then supplied into the interior.

The dehumidification and temperature adjustment mode is used in spring/autumn when an outside temperature is not very hot or cold, i.e. when the outside temperature is 30 °C or less. In this case, an inlet/outlet coolant temperature difference is 25 °C or less in the first tube row 121 to which the cold coolant, more specifically, the coolant at an average temperature of 5 °C, is supplied. In addition, the inlet/outlet coolant temperature difference is 40 °C or more in the second tube row 122 to which the cold coolant, more specifically, the coolant at an average temperature of 70 °C, is supplied. Therefore, in the case of a design based on the same cross-sectional area, the heat dissipation performance of the second tube row 122 is high by 60% or more. Conversely, a relatively excessive thermal load may be applied to the first tube row 121. Furthermore, in the first tube row 121, dehumidification, i.e. the phase change of moisture in the air, needs to be induced. This, of course, requires much more heat transfer performance than the second tube row 122, which only requires an increase in air temperature without phase change.

As such, the first tube row 121 requires more performance than the second tube row 122 in terms of both operating conditions (average temperature of the supplied cooling water) and roles (phase change of moisture in the air) in the dehumidification and temperature adjustment modes. However, in the case of the two-row heat exchanger in the related art, the same tube is used for the first and second tube rows, so that the heat dissipation performance of each row is identical. As a result, there is a problem in which the performance deteriorates because an excessive heat load is applied to the first tube row 121.

In the present invention, in order to solve the problem, the tube width t1 of the first tube row 121 is set to be larger, which improves the heat transfer performance of the first tube row 121. In the example above, considering that the heat dissipation performance of the second tube row 122 is approximately 60% higher under the same tube width conditions, the tube width t1 of the first tube row 121 may be approximately 167%, which is the reciprocal of 60%. Meanwhile, in case that the tube width t1 of the first tube row 121 is excessively increased, there is a concern that the overall thickness of the heat exchanger 100 is excessively increased or the performance of the second tube row 122 excessively deteriorates relatively. In contrast, in case that the tube width t1 of the first tube row 121 is too small, the heat transfer performance improvement effect of the first tube row 121 may not be satisfactory. In consideration of these various factors, the tube width t1 of the first tube row 121 may be appropriately determined, preferably around the above-mentioned 167%. More specifically, it is desirable that the tube width t1 of the first tube row 121 is formed to have a size in a range of 120 to 200% of the tube width t2 of the second tube row 122.

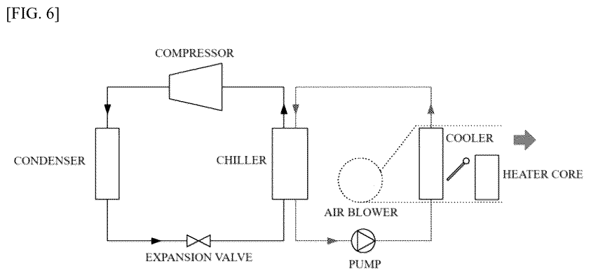

The above description provides an example of the case in which the coolants with different temperature ranges flows in the two rows of the exchanger 100. However, the present invention is not limited thereto. For example, the heat exchanger 100 may serve as a chiller of the heat exchange system having the primary and secondary loops in FIG. 6 described above. In this case, like the configuration in which the refrigerant and the coolant respectively flow in the two rows of the heat exchanger 100, the heat exchange media completely different from each other may flow. Even in this case, as necessary, the introduction of the structure of the heat exchanger 100 of the present invention may further improve the heat exchange performance.

However, in case that the heat transfer performance is improved by increasing the tube width t1 of the first tube row 121 as described above, the following new problems may occur. As described above, in the dehumidification and temperature adjustment mode, the cold coolant flows in one of the two rows, and the hot coolant flows in the other of the two rows. In most cases, the fins provided on the two-row heat exchanger are integrated and elongated to be in contact with both rows. As a result, one side of the fin is cold, and the other side of the fin is hot, which may cause a concern that heat is transferred by thermal conduction, and heat transfer performance in the respective rows deteriorates.

The shapes of the fins are appropriately illustrated in FIG. 3. As illustrated in FIG. 3, the heat exchanger 100 may include a plurality of fins 130 interposed between the tubes 120 and extending to be in contact with both the first tube row 121 and the second tube row 122. In this case, a plurality of louvers may be formed on the fin 130 and arranged in a flow direction of the air. A fin having no louver may be used. However, In the present invention, the above-mentioned problem is to be solved by using a louver shape design, and therefore, the fin 130 used in the present invention may be a louver fin.

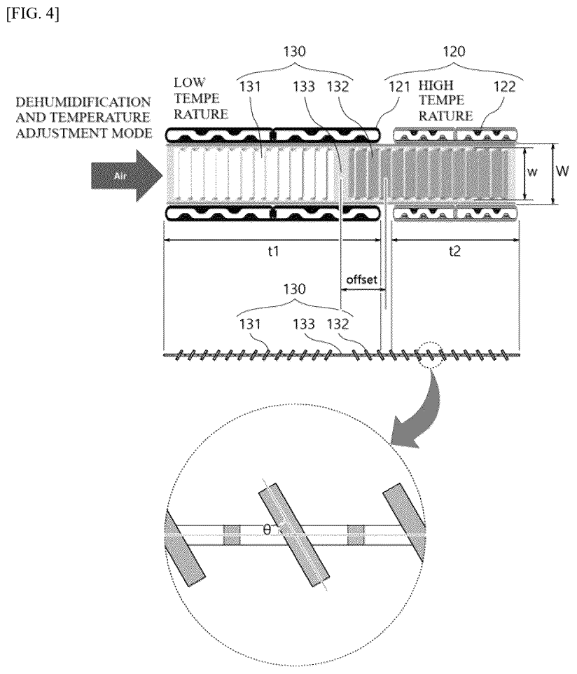

The louver of the general louver fin is made by slitting a part of a fin surface and twisting and inclining the fin surface. FIG. 4 is a detailed view illustrating the two-row heat exchanger of the present invention in a tube cross-section direction and a fin cross-section direction. In the detailed view in the fin cross-section direction, a shape of a cross-section of the fin 130 in which the louver is formed to have an inclination angle of with respect to the fin surface is appropriately shown.

Meanwhile, in a general louver fin, the louver is formed to be bidirectionally inclined instead of being inclined only in one direction. Even in the present invention, the louver is formed to be bidirectionally inclined, as described above, and the louver will be specifically described. When a louver row having the plurality of louvers disposed at a side at which air is introduced is referred to as a first louver row 131 and a louver row disposed at a side at which air is discharged is referred to as a second louver row 132, angles at which the first louver row 131 and the second louver row 132 are inclined are formed in opposite shapes symmetric to each other. In this case, a bank 133, which is a region in which the first louver row 131 and the second louver row 132 are spaced apart from each other, is formed at a center of the fin 130.

Because the first and second row tube widths are identical in the case of the two-row heat exchanger in the related art, the bank 133 formed at the center of the fin 130 is consistent with a spacing portion (gap) between the first and second tube rows. However, because the first and second row tube widths are different from each other in the case of the heat exchanger of the present invention, the bank 133 is positioned to be shifted from the spacing portion between the first and second tube rows. More clearly, the fin 130 of the present invention is formed such that the bank 133 is disposed in a region in which the fin 130 is in contact with the first tube row 121.

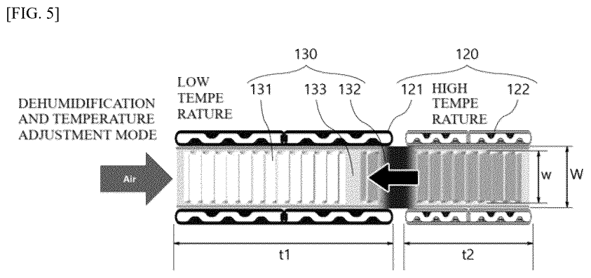

As described above, in the dehumidification and temperature adjustment mode, the cold coolant flows in the first tube row 121, and the hot coolant flows in the second tube row 122, such that one side of the fin 130, which is in contact with both the first and second row has a low temperature, the other side has a high temperature, and as a result, thermal conduction occurs necessarily. In the related art, the first tube row-first louver row-low temperature region/second tube row-second louver row-high temperature region are formed to be consistent with one another, and as a result, thermal conduction from a low temperature region to a high temperature region occurs in the bank 133. However, in the present invention, the first tube row-low temperature region/second tube row-high temperature region are consistent with each other but shifted from the first louver row/second louver row, and as a result, thermal conduction from the low-temperature region to the high-temperature region does not occur in the bank 133 but occurs in a region of one of the plurality of louvers (more specifically, one of the louvers included in the second louver row 132). FIG. 5 explicitly illustrates this thermal conduction region, and the region in which the thermal conduction actively occurs from the high-temperature region to the low-temperature region is shown in a darker color.

As explicitly ascertained from FIG. 5, in the present invention, the thermal conduction region is formed over at least one louver instead of being formed in the bank 133. More specifically, the fin 130 is formed such that at least one louver is disposed between the first tube row 121 and the second tube row 122. In this case, as described above, the louver is made by cutting, twisting, and inclining a part of the fin surface, and the louver portions are not actually connected. In this case, thermal conduction does not occur. In other words, in this case, heat conduction only occurs in the portion remaining after the louver is formed, and this region is much narrower than the total width because it is only left small enough to support the louver. That is, in the related art, thermal conduction occurs through the region of the overall width of the fin. In contrast, in the present invention, because thermal conduction occurs only through the region of the width of the louver support portion, thermal conduction occurs much less than in the related art. More specifically, as illustrated in FIGS. 3 to 5 and the like, a width (w) of the louver may be formed to have a size in a range of 80 to 90% of a width (W) of the fin 130. Then, because a width of the region in which the thermal conduction occurs corresponds to a portion excluding the width of the louver, the width of the louver is only about 10 to 20% of the width of the fin 130, which may block almost all heat transfer substantially by thermal conduction.

The present invention is not limited to the above embodiments, and the scope of application is diverse. Of course, various modifications and implementations made by any person skilled in the art to which the present invention pertains without departing from the subject matter of the present invention claimed in the claims.

### INDUSTRIAL APPLICABILITY

According to the present invention, in the two-row heat exchanger, i.e., in the heat exchanger in which the inlet and the outlet are separately provided in the first and second rows, the width of the first row is larger than the width of the second row based on the flow direction of the air, thereby improving overall heat exchange performance of the heat exchanger. However, in this case, a loss may be caused by heat transfer between the first and second rows. In the present invention, the position of the bank of the fin having the louver is spaced apart from the spacing position between the tube rows, which may maximally prevent a loss caused by thermal conduction.

1. A heat exchanger comprising:
a pair of header tanks provided in two rows and each having therein a fluid flow space in which a heat exchange medium flows; and
a plurality of tubes arranged in two rows and each having two opposite ends fixed to the pair of header tanks, which are disposed to be spaced apart from each other, to form a flow path for the heat exchange medium, wherein when a tube row disposed at a side at which air is introduced is referred to as a first tube row and a tube row disposed at a side at which air is discharged is referred to as a second tube row based on a flow direction of the air passing through the tube, a tube width of the tube in the first tube row is larger than a tube width of the tube in the second tube row.

2. The heat exchanger of claim 1, comprising:
a plurality of fins interposed between the tubes and extending to be in contact with both the first tube row and the second tube row, wherein a plurality of louvers arranged in the flow direction of the air are formed on the fin.

3. The heat exchanger of claim 2, wherein when a louver row having the plurality of louvers disposed at the side at which the air is introduced is referred to as a first louver row and a louver row disposed at the side at which the air is discharged is referred to as a second louver row, the fin is formed such that angles at which the first louver row and the second louver row are inclined are formed in opposite shapes symmetric to each other.

4. The heat exchanger of claim 3, wherein the fin is formed such that a bank, which is a region in which the first louver row and the second louver row are spaced apart from each other, is formed at a center of the fin.

5. The heat exchanger of claim 4, wherein the fin is formed such that the bank is disposed in a region in which the fin is in contact with the first tube row.

6. The heat exchanger of claim 5, wherein the fin is formed such that at least one louver is disposed between the first tube row and the second tube row.

7. The heat exchanger of claim 5, wherein the louver is formed such that a width of the louver has a size in a range of 80 to 90% of a width of the fin.

8. The heat exchanger of claim 1, wherein the tube width of the first tube row is formed to have a size in a range of 120 to 200% of the tube width of the second tube row.

9. The heat exchanger of claim 1, wherein the first tube row and the second tube row are completely isolated from each other so that heat exchange media having different temperatures flow.

10. The heat exchanger of claim 9, wherein coolants circulating through different cooling cycles respectively flow in the first tube row and the second tube row.

11. The heat exchanger of claim 10, wherein in a dehumidification and temperature adjustment mode or a heating mode, a temperature of the heat exchange medium flowing in the first tube row is lower than a temperature of the heat exchange medium flowing in the second tube row.

12. The heat exchanger of claim 10, wherein a first inlet port and a first outlet port for allowing one heat exchange medium to flow are provided in the first tube row, and a second inlet port and a second outlet port for allowing the heat exchange media having different temperatures to flow are provided in the second tube row independently of the first inlet port the first outlet port.
